(19) United States
(12) Patent Application Publication
(10) Pub. No.: US 2006/0276239 A1
(43) Pub. Date: Dec. 7, 2006

(54) Direct conversion radio station operable pursuant to a coded squelch scheme and associated method

(76) Inventors: Man Lung Lam, Hong Kon (HK); Man Tai Vincent Lam, Hong Konk (HK)

Correspondence Address: SCHEEF & STONE, L.L.P., 5956 SHERRY LANE, SUITE 1400, DALLAS, TX, 75225, US

(21) Appl. No.: 11/143,907

(22) Filed: Jun. 2, 2005

(51) Int. Cl. H04B 1/00; H04Q 7/20; H04M 11/00; H04B 7/00; H04B 1/10

(52) U.S. Cl. 455/701; 455/68

(57) ABSTRACT

A personal radio service radio, such as an MURS or FRS radio, that is of a direct conversion architecture. The radio is formed of a base-band stage and a radio frequency stage. Communication data is direct-converted between the base-band and radio frequency stages, obviating the need for an intermediate frequency stage. The radio, in one implementation, forms a multi-mode radio capable alternately of operation pursuant to MURS communications and pursuant to FRS communications.

The present invention relates generally to a manner by which to operate a radio communication station that communicates pursuant to a coded squelch scheme during operation of a radio communication system. More particularly, the present invention relates to apparatus, and an associated method, by which to operate upon signals generated during operation of the radio communication system.

A direct conversion architecture is provided that directly converts received RF (Radio Frequency) signals to base-band levels and converts transmit signals of base-band levels to RF levels. By obviating the need for an IF (Intermediate Frequency) stage at the radio communication station, costs associated with the IF stage are obviated. And, the circuitry of the radio communication station is of reduced dimensions. Deleterious shadowing effects that sometimes occur at the IF stage are obviated. A radio of reduced dimensions and costs, which does not require circuitry to compensate for the effects of shadowing, is provided. The radio communication station is implemented as, e.g., an MURS, FRS, PMR, short range radio, multi-mode radio, or other radio that operates pursuant to a coded squelch sequence scheme.

### BACKGROUND OF THE INVENTION

Communication systems that provide for the communication of information between space-apart locations are pervasive throughout modem society. Access to a communication system through which to communicate is, for many, a necessary aspect of modern society. Communication services are effectuated through the communication of data by way of a selected communication system. Communication services include one-way communication services and two-way communication services.

A large number of different types of communication systems have been developed and made available for users to utilize in order to effectuate a selected communication service. And, new communication systems shall likely continue to be developed and deployed as advancements in communication technologies are made available.

A radio communication system is an exemplary type of communication system. In a radio communication system, communications are effectuated between a set of communication stations. At least one of the communication stations forms a sending station, and at least one of the communication stations forms a receiving station. The sending and receiving stations of the set of communication stations are interconnected by way of the radio channel. A radio channel is defined upon a radio link, i.e., a portion of the electromagnetic spectrum. Data that is to be communicated to effectuate a communication service is caused to be sent by the sending station upon the radio channel. And, the receiving station operates to detect the communicated data as the data is delivered to the receiving station, subsequent to communication upon the radio channel.

In contrast, conventional wire line communication systems require that communication stations be interconnected by conventional wire line connections. Free of the need to interconnect the communication stations by way of the wire line connections, the communication stations of a radio communication system are permitted to be positioned at locations between which the wire line connections are not available. And, a radio communication system is amenable for implementation as a mobile communication system in which one or more of the communication stations of the set of communication stations is provided with mobility.

Some radio communications systems include fixed network infrastructures with which communication stations communicate. In some of such communication systems, the communication stations that communicate with the network infrastructure is permitted mobility. In other radio communication systems, communications are effectuated without the use of network infrastructure. That is to say, communications are effectuated directly between communication end points, e.g., between a set of communication stations.

Regulatory bodies have allocated portions of the electromagnetic spectrum for unlicensed access to users to communicate upon radio channels defined within the allocated frequency bands.

For instance, channels defined at 151 and 154 MHz are available for use pursuant to a private, two-way, short-distance voice or other data communication service for the general public. The communication service is referred to as a MURS (Multi-User Radio Service). MURS-compatible communication stations are commercially available, and are regularly utilized to communicate voice, and other, data between the MURS-compatible stations. The allocated frequency band, providing unlicensed, and essentially unregulated, communications on shared channels requires a mechanism by which a set of communication stations that are to be parties to a communication service or session identify themselves so that communications are effectuated between the appropriate communication stations of the communication station set.

Coded squelch schemes are utilized by MURS-radio stations by which to identify communication stations and to facilitate communications between which communications are to be effectuated. Continuous tone coded squelch system (CTCSS) schemes and digital coded squelch (DCS) schemes are both known and commonly utilized.

So-called family radio service (FRS)-compatible radio stations are also commercially available. Radio communications between FRS-compatible stations are effectuated within an unlicensed band located at 460 MHz. Analogous to MURS-compatible radios, FRS-compatible radios utilize coded squelch schemes to identify communication stations between which communications are to be effectuated.

Other unlicensed radio bands are allocated for the effectuation of other communication services, such as short range radio services and other mobile radio services.

Multi-mode radios, permitting their operation to effectuate communications pursuant to two or more communication service types, are available. However, whether the radios are single-mode or multi-mode, the radios are conventionally of at least three-stage constructions. That is to say, radios are conventionally of constructions that include an RF (Radio Frequency) stage, an IF (Intermediate Frequency) stage, and a BB (Base-Band) stage. At the IF stage, for instance, subsequent to a down-mixer, a filter is required to be utilized to filter unwanted components, such as harmonic components. And, shadowing is sometimes exhibited, depending upon the down-mixing frequency and the radio frequency at which an input signal is applied to the IF stage.

While direct conversion architectures and technologies are generally known, such technologies have not generally been applied to radio stations that utilize coded squelch schemes. A direct conversion architecture scheme would obviate the need of a radio to utilize an IF stage, thereby permitting its construction to be simplified, its dimensional requirements to be reduced, and to reduce the possibility of the occurrence of shadowing.

What is needed, therefore, is a MURS-compatible, FRS-compatible, or other personal-radio-service radio that is constructed of a direct conversion architecture.

It is in light of this background information related to radio communications stations that the significant improvements of the present invention have evolved.

### SUMMARY OF THE INVENTION

The present invention, accordingly, advantageously provides apparatus, and an associated method, for a radio communication station that communicates during operation of a radio communication system pursuant to a coded squelch scheme.

Through operation of an embodiment of the present invention, a manner is provided by which to operate upon signals generated during operation of the radio communication system.

In one aspect of the present invention, the radio communication station is provided with a direct conversion architecture. The direct conversion architecture directly converts received RF signals to base-band levels. And, transmit signals of base-band levels are directly converted to RF levels.

Through use of the direct conversion architecture, the need for an IF (Intermediate Frequency) stage at the radio communication station, the part count of the radio, and its associated cost, is reduced. Additionally, by obviating the need for the IF stage, e.g., the IF-stage filter and other bulky circuitry, is obviated. A radio of reduced dimensions, relative to radios that require the use of an IF stage, is provided. Additionally, shadowing effects, sometimes exhibited at the IF stage as a result of down-mixing also does not occur. And, compensation for the effects of shadowing need not be made.

In another aspect of the present invention, an MURS (Multi-User Radio Service) radio communication station is provided. The MURS-compatible station is formed of a direct conversion architecture that directly converts between radio frequency and base-band levels, obviating the need for an intermediate frequency stage. Transmit data, originated at the MURS radio is directly converted to a radio frequency of a radio frequency of a frequency within the frequency band allocated for MURS communications. And, receive data, delivered to the MURS radio, is directly converted to a base-band level from the radio frequency level at which the receive data is communicated to the MURS radio.

In another aspect of the present invention, an FRS (Family Radio Service) radio communication station is provided. The FRS-compatible communication station is formed of a direct conversion architecture. Transmit data, originated at the FRS radio is directly converted from a base-band level to a radio frequency level within the frequency band allocated for FRS communications. And, receive data, received at the FRS radio, is directly converted from radio frequency levels to base-band levels. Once converted to base-band levels, the data is operated upon to recover the informational content thereof.

In a yet further aspect of the present invention, a multi-mode, personal radio service, radio communication station is provided. The multi-mode radio provides, e.g., for MURS and FRS communication services. The circuitry of the multi-mode radio forms a direct conversion architecture having a radio frequency stage and a base-band stage. The radio frequency stage includes a receive portion capable of receiving the MURS and FRS data. The receive portion is formed, for instance, of a first receive part and a second receive part, the separate parts of which operate to receive the MURS and FRS data, respectively. And, the multi-mode radio includes a transmit portion capable of transmitting the MURS and FRS data. The transmit portion is formed, for instance, of a first transmit part and a second transmit part, the separate parts of which operate to transmit the MURS and FRS data, respectively.

In other implementations, the radio communication station includes a direct conversion architecture and is operable pursuant to other personal radio services. And, a multi-mode radio that provides for such other radio communication services is formed of other combinations of circuitry, utilizing direct conversion architectures.

In these and other aspects, therefore, apparatus, and an associated method, is provided for a two-way radio communication station. The radio communication station operates pursuant to a coded squelch system to initiate communication of communication data with a remote station. The apparatus operates upon communication data generated during a communication session with the remote station. A base-band element operates at base-band frequencies upon the communication data communicated during the communication session. A radio-frequency element is connected directly to the base-band stage. The radio-frequency element operates at radio frequencies upon the communication data communicated during the communication session. The radio-frequency element further directly converts the communication data between the radio frequencies and the base-band frequencies.

A more complete appreciation of the present invention and the scope thereof can be obtained from the accompanying drawings that are briefly summarized below, the following detailed description of the presently-preferred embodiments of the present invention, and the appended claims.

### BRIEF DESCRIPTION OF THE DRAWINGS

FIG. 1 illustrates a functional block diagram of a radio communication station of an embodiment of the present invention.

FIG. 2 illustrates a representation of the conversion operations performed at the radio communication station shown in FIG. 1 to directly convert radio frequency signals to base-band levels.

FIG. 3 illustrates a functional block diagram of a radio communication station of a further embodiment of the present invention.

FIG. 4 illustrates a method flow diagram listing the method of operation of an embodiment of the present invention.

### DETAILED DESCRIPTION

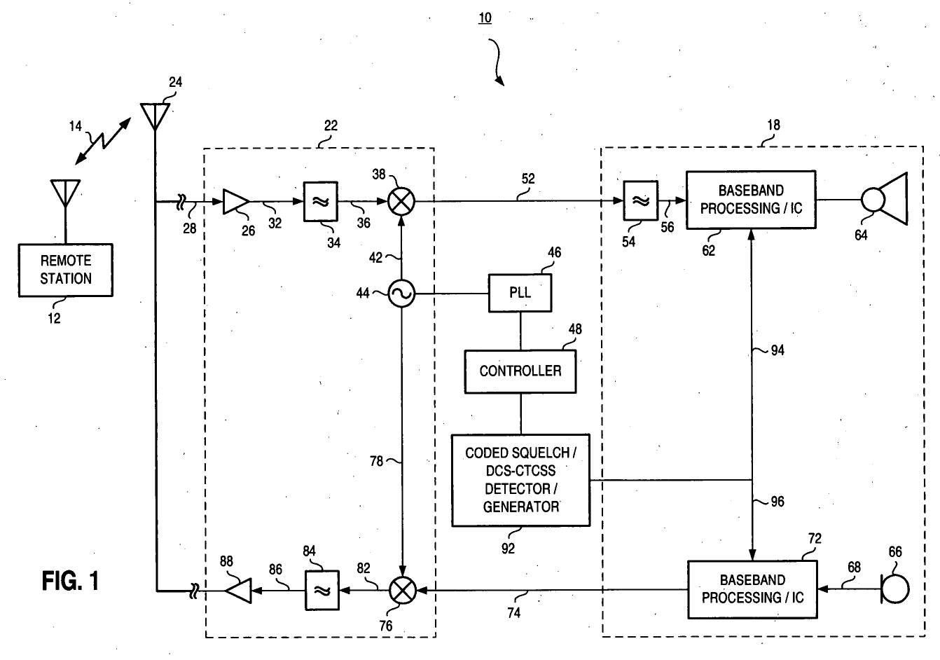

Referring first to FIG. 1, an exemplary radio communication station, shown generally at 10, operates to transmit and to receive radio frequency signals. The radio communication station operates to communicate with a remotely-positioned radio communication station 12 by way of radio channels 14 defined upon a radio link. Two-way communication of communication data is effectuated between the communication station 10 and the remote station 12. That is to say, communication data originated at the communication station, 10 is caused, during operation of the communication station, to be communicated to the remote station by way of a radio channel 14 defined upon the radio link. And, communication data originated at the remote station 12 and communicated upon a radio channel 14 for delivery to the communication station 10 is detectable at the communication station 10 whereat the informational content of the communication data is recovered.

The communication station operates pursuant to a coded squelch scheme, such as a continuous tone coded squelch system (CTSS) or digital coded squelch (DCS) scheme. The communications stations 10 and 12, as well as others, operable in an unlicensed frequency band, here in an infrastructure-free arrangement, utilize the coded squelch scheme by way of which to cause the communication stations to communicate only with appropriate other ones of the communication stations that might be concurrently operable within the same frequency band. When a continuous tone coded squelch system scheme is utilized, a specific, low-frequency sub-audible, audible tone is sent along with communication data by a sending station on the radio channel 14. If a receiving station recognizes the tone that is sent, the receiving station opens the squelch and permits the communication data transmitted by the sending station to be displayed, e.g., in aural form, at the receiving station. Communication data of only the communication station that sends the correct tone, is displayed at the receiving station. In a multi-station communication scenario, communication data of additional communication stations, also identified by the correct tone, is used at the communication station. In conventional, CTCSS operation, the tones that are selected for communication together with other communication data are selected from a set in which none of the tones of the set are harmonics of one another.

A digital coded squelch scheme operates in analogous manner but, instead of communication of a sub-audible, audio tone, a digital code is transmitted by a communication station during its operation.

The communication station 10 is constructed utilizing a direct conversion architecture in which the data-containing communication signals originated at, or delivered to, the communication station are directly converted between radio frequency levels and base-band levels. By directly converting the signals between base-band and radio frequency levels, the need for an intermediate frequency stage is obviated. The direct conversion architecture is provided for both a transmit part and for a receive part of the communication station.

Here, a base-band stage 18 and a radio frequency stage 22 are represented, respectively, to encompass both the transmit and receive portions of the communication station. The radio frequency stage 22 is coupled to an antenna transducer 24 that transduces signals between electromagnetic and electrical form. The antenna transducer is coupled to both the transmit portion and the receive portion of the RF stage of the communication station. The antenna transducer is, for instance, connected to the receive and transmit portions of the communication station by way of an antenna switch (not shown).

The receive portion of the RF stage includes an amplifier 26 that is coupled to receive signals on the line 28 representative of receive signals detected by the antenna transducer 24. The amplifier form amplified representations on the line 32 that is provided to a filter 34. The filter performs filtering operations to form a filtered representation of a signal on the line 36. The line 36 is provided to an input port of a down-mixer 38. A down-mixing signal is provided hereby way of the line 42, to another input port of the down-mixer circuit. The down-mixing signal provided by way of the line 42 is provided by an oscillator 44 whose frequency is controlled by a phase lock loop (PLL) circuit 46. The operation of the PLL is controlled by a controller 48.

The down-mixing circuit 38 down-mixes the radio frequency signal provided on line 36 with the down-mixing signal 42 to form a down-mixed signal on the line 52 that is of a base-band frequency level.

Line 52 extends to the base-band stage 18 of the receive portion of the communication station. The base-band stage of the receive portion is here shown to include a filter 54 that filters the base-band-level signal generated by the down-mixing circuit to form a filtered representation on the line 56. The filtered representation of the signal is provided to a base-band processing unit/integrated circuit 62. Base-band-level processing is performed thereat. And, once processed, the signals are transduced into human perceptible form, here by an acoustic transducer 64.

The transmit portion of the communication station embodied at the base-band stage 18 here includes an acoustic tranducer forming a microphone that converts acoustic energy into electrical form on the line 68. The line 68 extends to a base-band processing unit/integrated circuit (IC) 72. The circuits 62 and 72, in one implementation, are embodied at a common integrated circuit.

Once processed by the processing unit 72, representations of the data to be communicated by the communication station are generated on the line 74 that is provided to a first input of an up-mixing circuit 76. An up-mixing signal is provided, by way of the line 78, to a second input port of the up-mixing circuit. The up-mixing circuit operates to combine the signals generated on the lines 74 and 78 form an up-mixed signal on the line 82. The up-mixed signal is provided to a filter 84 that filters the up-mixed signal to form a filtered representation on the line 86 that is provided to an amplifier 88. The amplifier amplifies the filtered, up-mixed signal to be a power levels suitable for transmission to the remote station. The elements 76, 84, and 88, as well as others, form part of the radio frequency stage of the transmit portion of the communication station.

The communication station is further shown to include a coded squelch (detector and generator). The coded squelch detector and generator operates in conventional manner to generate sub-audible tones or digital codes or to detect tones or codes transmitted to the communication station. Operation of the squelch detector and generator is controlled by the controller, and the element is coupled to the base-band processing unit 62 and 72, here by way of lines 94 and 96, respectively.

Because the communication station operates both to send and to receive communication data pursuant to a personal radio service, such as an MURS, FRS, or other radio service, the communication station is economically manufactured and is of reduced dimensional requirements relative to conventional transceivers.

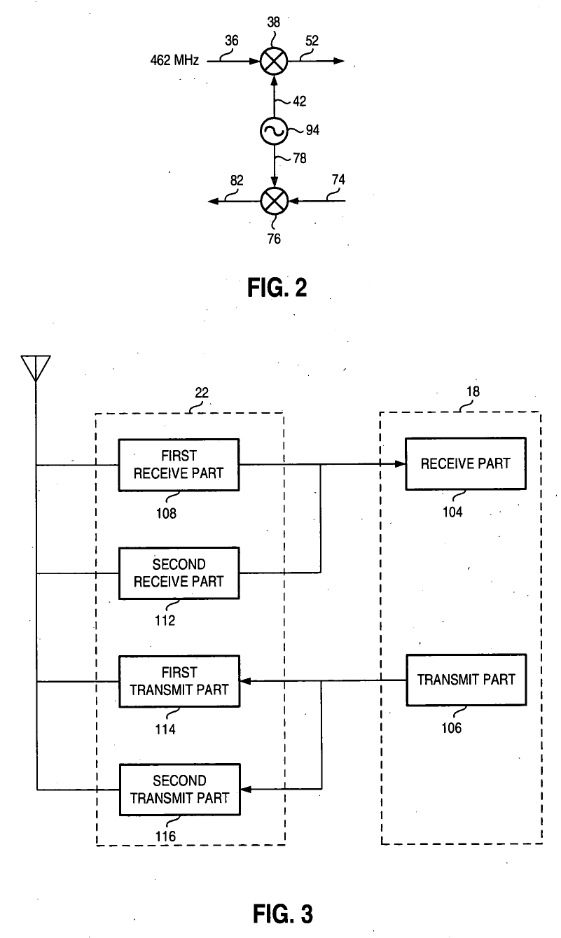

FIG. 2 illustrates a representation of exemplary mixing operations performed by the mixers 38 and 76 of the communications station 10 of the exemplary embodiment of the communication station 10 shown in FIG. 1. Lines 36 and 42 extending to the down-mixing circuit 38 and the lines 74 and 78 extending to the up-mixing circuits 76 are also again shown. Additionally, the lines 52 and 82 extending from the mixing circuits 38 and 76, respectively, are also again shown.

Here, the signal provided on the line 36 is of a frequency level of 462 MHz. And, the down-mixing signal generated on the line 42 is also of a 462 MHz frequency level. The down-mixing circuit combines, subtractive operation, the signals provided thereto, and the resultant signal formed on the line 52 is of a base-band level.

The operation of the up-mixing circuit 76 is analogous, but opposite. That is to say, the input signal provided by way of the line 74 is of a base-band level. And, the input signal provided by way of the line 78 is of a 462 MHz frequency level. The up-mixed signal, in combination of the base-band level signal and the up-mixing signal is also of a 462 MHz level. Thereby, operation of the mixing circuits 38 and 76 directly convert the signals between radio frequency and base-band levels, or vice versa. Shadowing effects exhibited when an intermediate frequency stage is utilized does not occur due to the direct conversion of the signals.

FIG. 3 illustrates a representation of a communication station 10 of another embodiment of the present invention. Here, the communication station forms a multi-mode device, capable of operation selectably to provide for the communication of data pursuant to a selected one of two or more personal communication services. Here, the multi-mode radio is selectably operable as an MURS radio and as an FRS radio. That is, the multi-mode radio forms a dual-mode radio.

The base-band stage 18 includes receive and transmit parts 104 and 106. The receive and transmit parts, both operable at base-band levels, are shared, each usable during operation of the communication station as an MURS radio and as an FRS radio. In an alternate implementation, the base-band receive circuitry is formed of separate parts, each operable pursuant to a separate radio communication service. And, analogously, in an alternate implementation, the base-band transceiver circuitry is formed of separate parts, each operable pursuant to a separate communication service.

The RF stage 22 of the communication station includes separate receive parts 108 and 112 operable pursuant to the separate services. That is to say, the receive part 108 operates as a radio frequency MURS radio stage. And, the receive part 112 operates as an FRS radio frequency stage.

Analogously, the RF stage 22 also includes separate transmit parts, here transmit parts 114 and 116. The transmit part 114 operates as an MURS radio transmitter. And, the transmit part 116 operates as an FRS radio transmit part.

Again, the communication stations formed of a direct conversion architecture in which signals are directly converted between base-band and RF frequencies. The need for an IF stage is obviated.

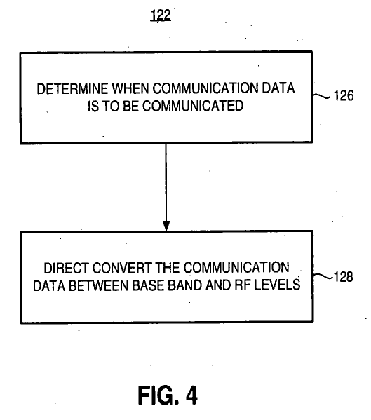

FIG. 4 illustrates a method flow diagram, shown generally at 122, representative of the method of operation of an embodiment of the present invention. The method is for operating upon communication data generated during a communication session of a two-way communication station that operates pursuant to a coded squelch system to initiate communication of communication data with a remote station.

First, and as indicated by the block 126, a determination is made, responsive to signaling generated pursuant to the coded squelch system, of when the communication of the communication data is to be initiated. And, upon initiation of the communication of the communication data, the communication data is direct-converted, as indicated by the block 128, at the two-way radio communication station between base-band levels and radio-frequency levels.

Because of the direct conversion of the communication data between the base-band and radio frequency levels, the need for an intermediate frequency stage, its associated costs and dimensional requirements, is obviated.

The previous descriptions are of preferred examples for implementing the invention, and the scope of the invention should not necessarily be limited by this description. The scope of the present invention is defined by the following claims.

We claim:

1. Apparatus for a two-way radio communication station that operates pursuant to a coded squelch system to initiate communication of communication data with a remote station, said apparatus for operating upon communication data generated during a communication session with the remote station, said apparatus comprising:
a base-band element for operating at base-band frequencies upon the communication data communicated during the communication session; and
a radio-frequency element connected directly to the base-band stage, said radio-frequency element for operating at radio frequencies upon the communication data communicated during the communication session, said radio-frequency element further for directly converting the communication data between the radio frequencies and the base-band frequencies.

2. The apparatus of claim 1 wherein said base-band element comprises at least a first receive part, said first receive part for operating upon first receive data received at the two-way radio communication station within a first frequency band, and converted to base-band levels.

3. The apparatus of claim 2 wherein said base-band element further comprises a second receive part, said second receive part for operating upon second receive data received at the two-way radio communication station within a second frequency band.

4. The apparatus of claim 1 wherein said base-band element comprises at least a first transmit part, said first transmit part for operating upon first transmit data to be transmitted by the two-way radio communication station within a first frequency band.

5. The apparatus of claim 4 wherein said base-band element further comprises a second transmit part, said second transmit part for operating upon second transmit data to be transmitted by the two-way radio communication station within a second frequency band.

6. The apparatus of claim 1 wherein said radio-frequency element comprises at least a first receive part, said first receive part for operating upon first receive data received at the two-way radio communication station within a first frequency band.

7. The apparatus of claim 6 wherein said radio-frequency element further comprises a second transmit part, said second transmit part for operating upon second transmit data to be transmitted by the two-way radio station within a second frequency band.

8. The apparatus of claim 1 wherein the coded squelch system pursuant to which the two-way radio communication system operates comprises an FRS (Family Radio Service) communication system and wherein said radio-frequency element which at least and FRS-band portion that operates at radio frequencies corresponding to a frequency band at which FRS communications are provided.

9. The apparatus of claim 8 wherein the coded squelch system pursuant to which the two-way radio communication system operates further comprises an MURS (Multi-User Radio Service) communication system further includes an MURS-band portion that operates at radio frequencies corresponding to a frequency band at which MURS communications are provided, the communication data directly converted by said radio-frequency element comprising both FRS data of the FRS-band portion and MURS-band portion.

10. The apparatus of claim 9 wherein said radio-frequency element comprises a frequency converter for directly converting the FRS data to base-band levels and for directly converting the MURS to base-band levels.

11. The apparatus of claim 10 wherein said frequency converter further directly converts base-band data to be transmitted by the two-way radio communication station to a selected one of the radio frequencies at which the MURS communications are provided and the radio frequencies at which the FRS communications are provided.

12. The apparatus of claim 1 wherein the coded squelch system pursuant to which the two-way radio communication system operates comprises an MURS (Multi-User Radio Service) communication system and wherein said radio frequency element includes at least a portion that operates at radio frequencies corresponding to a frequency band at which the MURS communications are provided.

13. The apparatus of claim 1 wherein said base-band element is embodied upon a first integrated circuit die and wherein said radio frequency element is embodied upon a second integrated circuit die.

14. The apparatus of claim 10 wherein the first integrated circuit die and the second integrated circuit die are packaged in a common package.

15. A method for operating upon communication data generated during a communication session of a two-way communication station that operates pursuant to a coded squelch system to initiate communication of communication data with a remote station, said method comprising the operations of:
determining, responsive to signaling generated pursuant to the coded squelch system, when the communication of the communication data is to be initiated; and, upon initiating the communication of the communication data
direct-converting the communication data at the two-way radio communication station between base-band levels and radio-frequency levels, such that the communication data is operated upon at the base-band levels and at the radio frequency levels.

16. The method of claim 15 wherein said operation of direct-converting comprises direct converting communication data to be communicated by the two-way radio communication station from the base-band levels to the radio frequency levels.

17. The method of claim 15 wherein said operation of direct-converting comprises direct-converting communication data received at the two-way radio communication station from the radio frequency levels to the base-band levels.

18. The method of claim 15 wherein the two-way radio communication station operates selectably as a MURS radio station and as an FRS radio station, and wherein said operation of direct converting comprises direct converting the communication data between the base-band levels and the FRS-band frequency levels.

19. The method of claim wherein the two-way radio communication station further operates to communicate data with a short range radio service band, and wherein said operation of down-converting further comprises direct converting communication data between the base-band levels and short range radio service band levels.

20. The method of claim 15 wherein said operation of down-converting comprises both up-converting and down-converting the communication data between the base-band levels and the radio frequency levels.
